(19) United States
(12) Patent Application Publication
(10) Pub. No.: US 2005/0234844 A1
(43) Pub. Date: Oct. 20, 2005

(54) Method and system for parsing XML data

(75) Inventor: Maxim A. Ivanov, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 10/820,897

(22) Filed: Apr. 8, 2004

(51) Int. Cl. G06F 7/00

(52) U.S. Cl. 707/1

(57) ABSTRACT

A system, method, and computer-accessible medium for facilitating parsing content from an XML document are provided. A parser and an agent processes XML events from an event-based XML reader in accordance with a parsing map. The parsing map defines XML elements of interest and custom parsing code. The agent comprises a communications channel through which it receives the parsing map, and further through which the agent returns the content of the defined XML elements. The agent further comprises a state machine that is automatically generated in accordance with the parsing map. The automatically generated state machine advantageously avoids the need for the user to construct their own state machine when parsing XML elements using an event-based XML reader.

### FIELD OF THE INVENTION

In general, the present invention relates to accessing data formatted using the Extensible Markup Language (XML), and, in particular, to systems and methods for parsing content from XML data.

### BACKGROUND OF THE INVENTION

The Extensible Markup Language (XML) is a text-based data representation format that facilitates universal access to data, particularly structured and semi-structured data that is often used to exchange information between computer systems. XML has been widely adopted, in large part because it is platform-independent and can be used with a variety of programming languages.

XML formatted data is comprised of elements, each of which are demarcated by a start tag (such as <first-name>) and an end tag (e.g., </first-name>.) The information between the two tags is the content of the element. For example,

<first-name>Maxim</first-name>
<last-name>Ivanov</last-name>

is XML formatted data for the name, Maxim Ivanov. Elements can be encapsulated by other elements, and further annotated with attributes that contain metadata about the element and its contents. For example, if the above name data is part of a student record, the XML data is formed into an XML document that represents a student and may be formatted as follows:

<student id=“123456”>

<first-name>Maxim</first-name>
<last-name>Ivanov</last-name>

</student>

Here, the “first-name” and “last-name” elements are encapsulated in the “student” element having an attribute “id,” the value of which is “123456,” and which may be interpreted as the identification number assigned to a student named Maxim Ivanov.

One of the challenges associated with using XML formatted data is parsing the usable content from XML documents. Existing application programming interfaces (APIs) to parse XML documents include tree-based APIs and event-based APIs. An example of a tree-based API is the Document Object Model (DOM) interface, which maps an XML document onto a hierarchical tree-based memory structure so that each element of the XML document occupies a node in the tree. Although flexible, the DOM interface is slow and consumes large amounts of memory. To locate the content of just one element of an XML document requires constructing a parsing tree for the entire document in memory, and traversing the nodes to reach the node for the desired element.

An example of an event-based API is the Simple API for XML, abbreviated as SAX. The SAX interface comprises a forward-only reader that moves across a stream of XML data and “pushes” events of interest (e.g., the occurrence of a start tag indicating the beginning of an element) to registered event handlers (such as callback methods in an application) to parse the element's content. The SAX event-based push model is not only faster, but also consumes less memory than the DOM tree-based interface—SAX allows an application to parse XML documents that are larger than the amount of available memory. One drawback, however, is that the push model employed by the SAX interface requires the application to construct a complex state machine to handle all of the events for an XML document, even if the application is only interested in events related to a particular element in the document.

Another example of an event-based API is the XMLReader written for use in Microsoft's .Net Framework. Like the SAX reader, the XMLReader is a forward-only reader that moves across a stream of XML data. However, instead of pushing events, the XMLReader employs a “pull” model to interface with applications. The pull model allows the application to process only those events related to elements in the XML document that are of interest and to skip the rest. As a result, in some cases the application can avoid having to construct a state table machine to handle the events. However, the XMLReader is limited to use in the Net environment, and is not designed for broader use, such as for use with applications written in unmanaged C++ code.

### SUMMARY OF THE INVENTION

To overcome the above-described problems, a system, method, and computer-accessible medium to facilitate parsing content from an XML document are provided. The system and method provide a parser and an agent to process XML events for XML elements from an event-based XML reader on behalf of the parser in accordance with a parsing map.

In accordance with one aspect of the present invention, the parser comprises the parsing map and custom parsing code. The parsing map defines the XML elements of interest and further identifies the custom parsing code that corresponds to the defined XML elements. The custom parsing code contains the logic used to parse the content of the defined XML element.

In accordance with another aspect of the present invention, the agent comprises a communications channel through which the agent receives the parsing map, and further through which the agent returns to the parser the content of the XML elements defined in the parsing map. The agent further comprises a state machine that is automatically generated in accordance with the parsing map. The state machine is responsible for handling the events related to the XML elements defined in the parsing map, including verifying the structure and consistency of the elements, extracting the elements' attributes, if any, and collecting the elements' contents for return to the parser via the communications channel. The automatically generated state machine advantageously avoids the need for the user to construct their own state machine.

In some instances, a parsing map may define an XML element that has already been defined in an existing parsing map of another parser. In accordance with yet another aspect of the present invention, rather than identifying the corresponding custom parsing code for the previously defined element, the new parsing map instead defines delegation code that joins the existing custom parsing code, referred to herein as joined parsing. Joined parsing advantageously facilitates the partition of custom parsing code into small re-usable functions that may be joined into new parsers as needed.

In accordance with yet other aspects of the present invention, a computer-accessible medium for facilitating parsing content from an XML document is provided. The computer-accessible medium comprises data structures and computer-executable components comprising a parser and an agent to process XML events for XML elements from an event-based XML reader on behalf of the parser in accordance with a parsing map. The data structures define the parsing map, communications channel, and other data used by the parser and agent in a manner that is generally consistent with the above-described method. Likewise, the computer-executable components, including the state machine and custom parsing code, are capable of performing actions generally consistent with the above-described method.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram overview of an exemplary system to facilitate parsing content from an XML document in accordance with an embodiment of the present invention;

FIG. 2 is a block diagram depicting in further detail an arrangement of certain components of the system to facilitate parsing content from an XML document illustrated in FIG. 1, and in accordance with an embodiment of the present invention;

FIGS. 3A-3B are flow diagrams illustrating certain aspects of the logic performed by a method to facilitate parsing content from an XML document in conjunction with the system illustrated in FIGS. 1 and 2, and in accordance with an embodiment of the present invention;

FIG. 4 is another flow diagram illustrating certain other aspects of the logic performed by a method to facilitate parsing content from an XML document in conjunction with the system illustrated in FIGS. 1 and 2, and in accordance with an embodiment of the present invention;

FIG. 5 is a block diagram of certain aspects of exemplary parsers used to implement parsing content from an XML document in accordance with an embodiment of the present invention; and

FIG. 6 is a block diagram of an exemplary parser and agent used to implement parsing content from an XML document in accordance with an embodiment of the present invention.

### DETAILED DESCRIPTION OF A PREFERRED EMBODIMENT

The following discussion is intended to provide a brief, general description of a computing system suitable for implementing various features of the invention. While the computing system will be described in the general context of a personal computer usable in a distributed computing environment, where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, personal digital assistants (PDAs), and other devices upon which computer software or other digital content is installed.

For the sake of convenience, much of the description of the computing system suitable for implementing various features of the invention includes numerous references to the Windows operating system and the SAX reader interface to XML. However, those skilled in the art will recognize that those references are only illustrative and do not serve to limit the general application of the invention. For example, the invention may be practiced in the context of other operating systems, such as the LINUX operating system, and in the context of event-based APIs to XML other than SAX.

While aspects of the invention may be described in terms of applications, agents, functions, maps, etc., executed or accessed by an operating system in conjunction with a personal computer, those skilled in the art will recognize that those aspects also may be implemented in combination with various other types of program modules or data structures. Generally, program modules and data structures include routines, subroutines, programs, subprograms, methods, interfaces, processes, procedures, functions, components, schema, etc., that perform particular tasks or implement particular abstract data types.

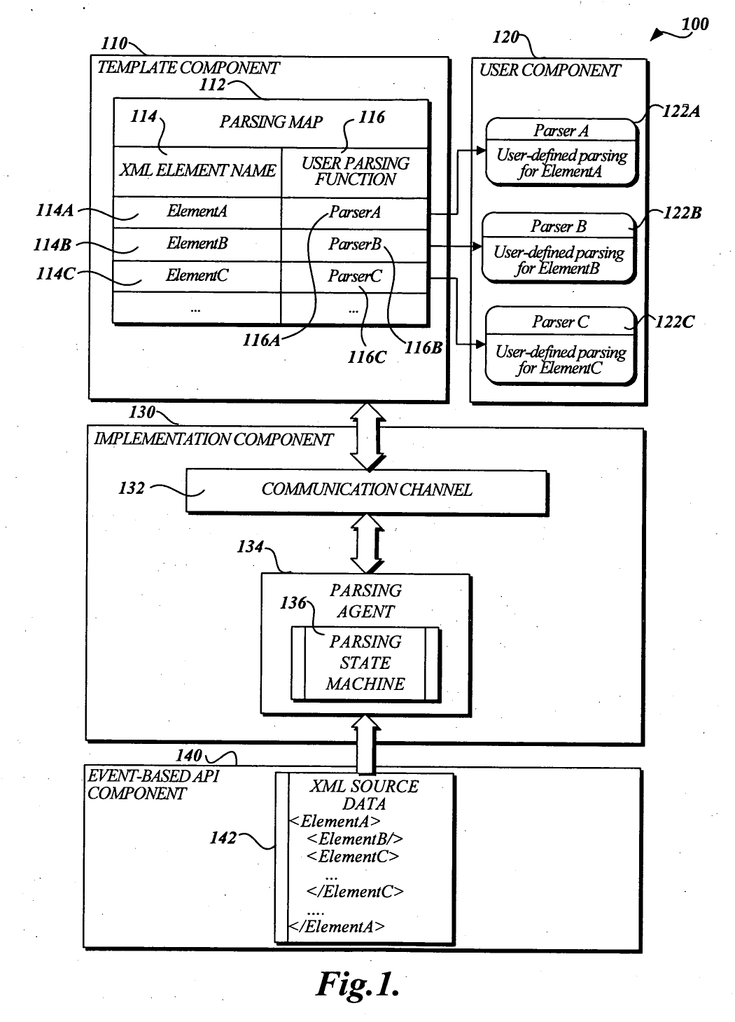

FIG. 1 is a block diagram overview of an exemplary system 100 to facilitate parsing content from an XML document in accordance with an embodiment of the present invention. As illustrated, the system includes, among other components, a template component 110, a user component 120, an implementation component 130, and an event-based XML reader component 140 that provides access to the elements of XML source data 142. The template component comprises a parsing map 112 that maps an XML element name 114 to a user-written parsing function 116. For example, in the illustrated parsing map 112 the XML element name ElementA 114A maps to user parsing function ParserA 116A, the XML element name ElementB 114B maps to user parsing function ParserB 116B, the XML element name ElementC 114C maps to user parsing function ParserC 116C, and so forth.

The user component 120 contains the user-written parsing functions 122 identified in the parsing map 112. For example, in the illustrated user component 120, the parsing function identified as ParserA 116A references the Parser A function 122A, the parsing function identified as ParserB 116B references the Parser B function 122B, the parsing function identified as ParserC 116C references the Parser C function 122C, and so forth. The parser functions 122 contain the custom parsing code that the user has written to customize the parsing of the content of the associated XML elements once that content is provided to them, as will be described in further detail below. Taken together, the template component 110 and the user component 120 comprise an XML parser that may be used to parse content from an XML document.

The implementation component 130 comprises a communication channel 132 that operates in conjunction with a parsing agent 134 to generate a parsing state machine 136 and to relay the content of XML elements in XML source data 142 back to the appropriate parsing functions 122 identified in the parsing map 112. During parsing, the parsing agent 134 accesses the parsing map 112 via the communications channel 132 to generate the parsing state machine 136 in accordance with the XML element names 114 defined in the map, and their corresponding user parsing functions 116. The parsing agent 134 handles events related to the XML elements 114 defined in the map 112 in accordance with the state machine 136 to verify the structure and consistency of the elements, to extract any attributes that may be present in the element, and to further collect the content of the element. The agent 134 returns the extracted attributes and collected content to the appropriate parsing function 122 via the communications channel 132 as determined from the user parsing functions 116 identified in the parsing map 112.

In a preferred embodiment, the system 100 is designed and implemented as an unmanaged C++ library that operates in conjunction with an event-based XML reader interface to XML data, such as the SAXReader interface to a SAX XML library. The unmanaged C++ library includes a template class that is responsible for communication with the user-written functions 122, and an implementation class that implements XML parsing and provides the content of the XML elements to the user-written functions 122 based on information from the template class.

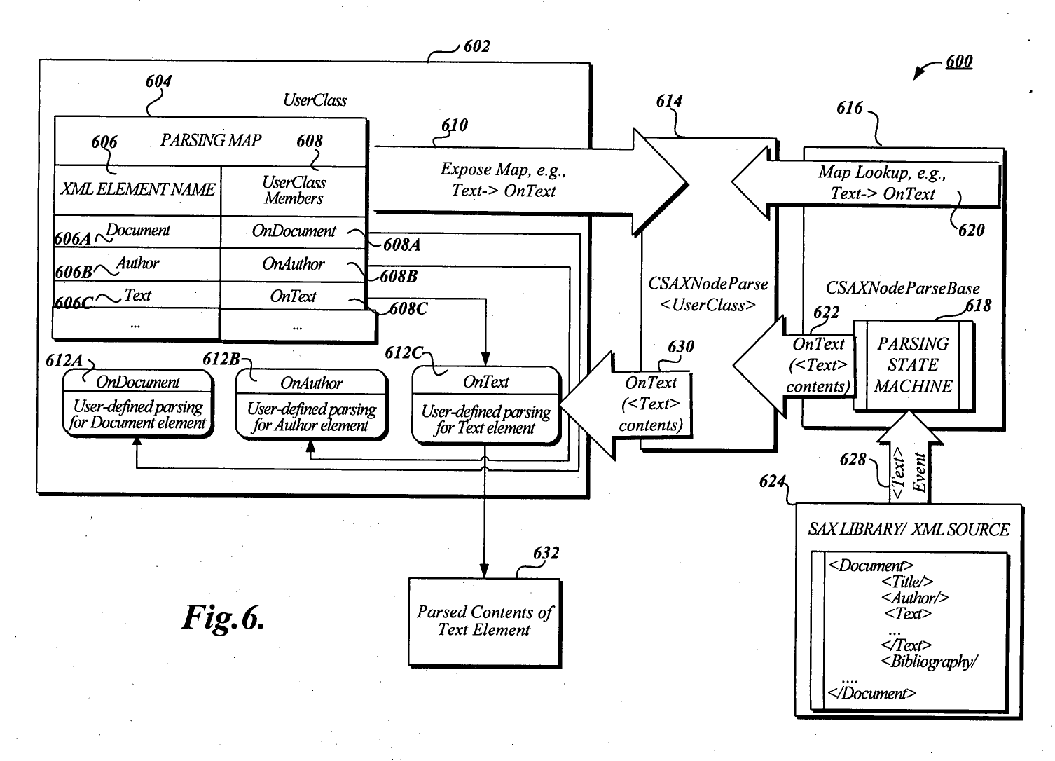

The template class generally corresponds to the template and user components 110, 120 of the system 100, and is part of a user class library, the members of which include the user-written functions 122. The user-written functions 122 inherit the characteristics of a pre-defined node parser class. The node parser class is created especially for the purpose of parsing content of elements from any XML data that is capable of being read by an event-based XML reader 140. For example, in one embodiment, the event-based XML reader 140 is the SAX reader, and the pre-defined node parser class from which the members of the user class library inherit their characteristics is pre-defined as the CSAXNodeParser class, which will be described in further detail in FIG. 6. Once the members of the user class library have been created, the user may define any number of parsing maps 112 that describe the XML elements of interest 114 and corresponding user parsing function class members 116, 122. In one embodiment, the user may join the parsing functionality embodied in parsing functions 122 already described in a previously defined parsing map to parsing functions in a new parsing map 112, as will be described in further detail below.

The implementation class is a pre-defined class that generally corresponds to the above-described implementation component 130. For example, in one embodiment, the implementation class is pre-defined as the CSAXNodeParserBase class, which is described in further detail in FIG. 6. Based on the parsing map 112 defined by the user, the CSAXNodeParserBase class generates the parsing state machine 136 for the XML elements of interest in the XML source data 142 contained in the XML library 140. In operation, the parsing state machine 136 is an internal state machine that performs various pre-parsing operations. The CSAXNodeParserBase class registers itself as a SAX parsing agent 134, and operates the state machine to consume events generated by the SAX Reader interface for XML elements of interest, i.e. to perform the various pre-parsing operations on the XML elements of interest.

In one embodiment, as the registered SAX parsing agent 134, the CSAXNodeParserBase class determines from the parsing map 112 which of the corresponding user parsing function class members 116, 122 to use as a callback method for a particular XML element, and further passes the content of the XML element to that callback method for custom parsing. In this manner, the implementation class not only operates as a parsing agent 134, but also operates as a communication channel 132 between the XML source data 142, and the user custom parsing functions 122.

It is understood that the above-described components 110, 120, 130, and 140 may be implemented alone or in combination with other components in a computing device (not shown) that includes an operating system that provides executable program instructions for the general administration and operation of the device as well as for the operation of the components. Suitable implementations for the operating system are known or commercially available, and are readily implemented by persons having ordinary skill in the art, particularly in light of the disclosure herein. Those of ordinary skill in the art will recognize that the computing device will also typically employ a memory and processor in which program instructions are stored and executed for operation of the components that comprise the system 100 to facilitate parsing an XML document. For example, the memory may include computer program instructions for implementing the user-written parsing functions that operate in cooperation with the parsing map 112, communication channel 132, parsing agent 134, parsing state machine 136, and XML source data 142 to facilitate parsing the XML data in accordance with an embodiment of the invention. Likewise, the memory may include other executable program instructions, such as instructions for the event-based API to the library that contains the XML source data 142.

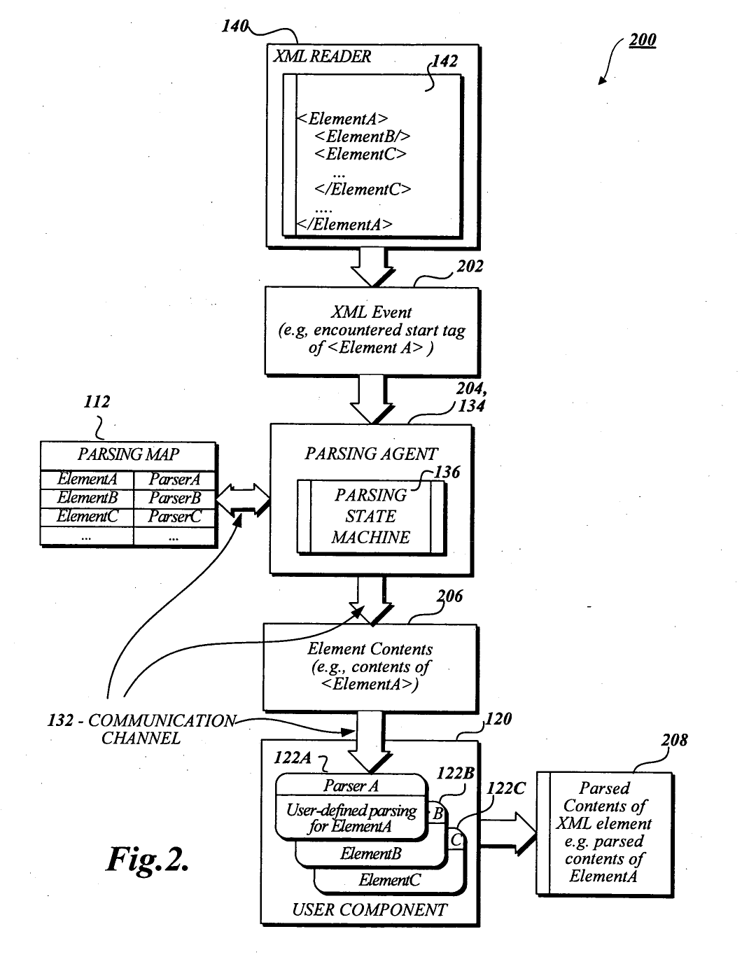

FIG. 2 is a block diagram depicting in further detail an arrangement of certain components of the system 100 to facilitate parsing content from an XML document illustrated in FIG. 1, and in accordance with an embodiment of the present invention. In particular, FIG. 2 depicts a simplified overview of the operational flow 200 of an embodiment of the invention when parsing an XML document. During operation, the XML Reader 140 generates XML Reader events 202 for elements from the XML source data 142. For instance, in the example illustrated in FIG. 2, the XML Reader event is encountering the start tag for XML element A, <Element A>. When an event is generated for an XML element that has been defined in the user's parsing map 112, the event 202 is processed by an XML parsing agent 204, 134. The XML parsing agent 204, 134 operates a parsing state machine 136 to pre-parse the XML element for which the event 202 was generated. In doing so, the XML parsing agent 204,134 accesses the parsing map 112 provided by the user via the communication channel 132 to determine whether there is a corresponding custom parsing function 122 that should be called. If so, the pre-parsed content of the XML element 206 is passed through to the appropriate parsing function 122 of the user component 120, also via the communication channel 132. The resulting custom-parsed content 208 of the XML element is then made available to the user's application or otherwise processed as desired. The operational flow 200 is repeated for each event generated for XML elements that have been defined in the user's parsing map 112. Events generated by the XML reader for other XML elements that have not been defined in the map 112 are bypassed.

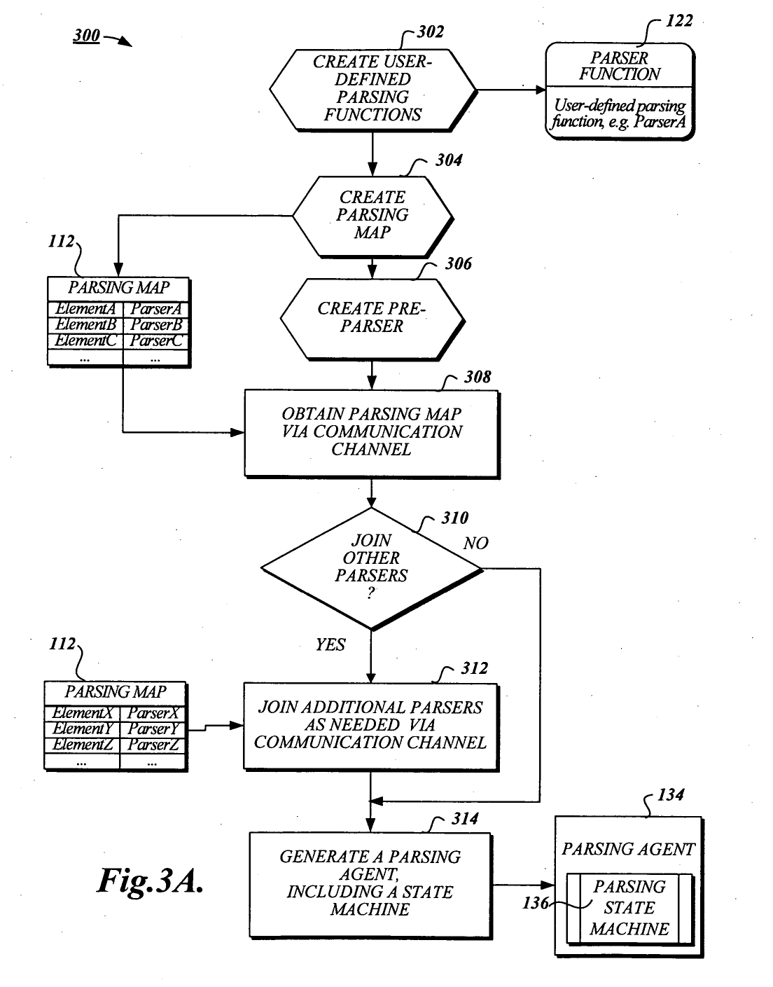

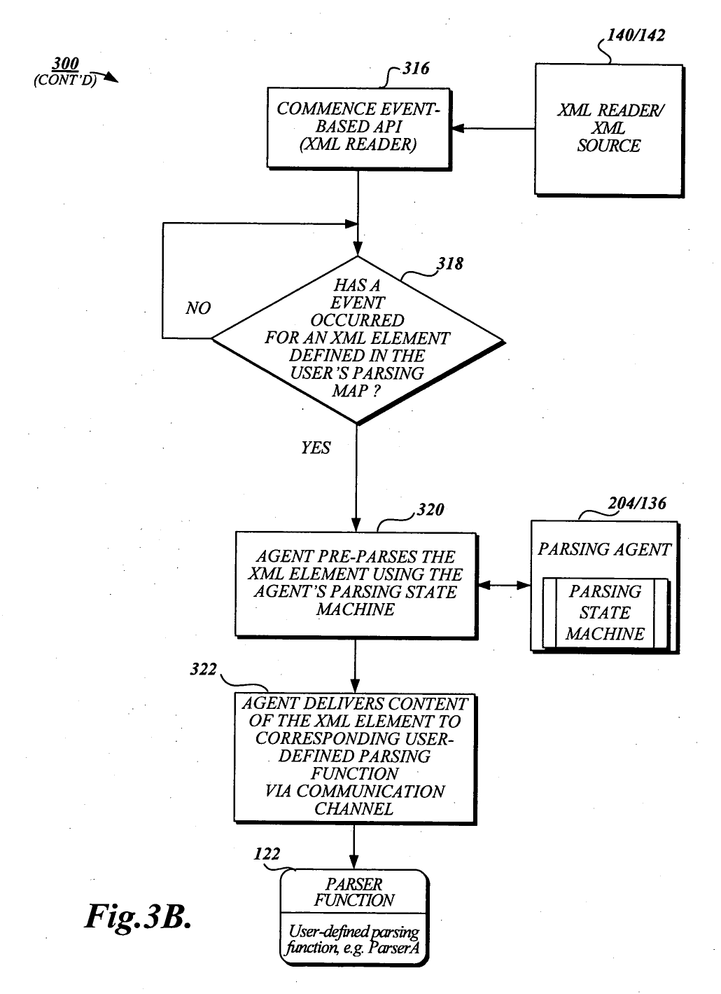

FIGS. 3A-3B are flow diagrams illustrating the logic 300 performed by a method to facilitate parsing content from an XML document in conjunction with the system 100 illustrated in FIGS. 1 and 2, and in accordance with an embodiment of the present invention. Beginning with the preparatory process 302, a user creates parser functions 122 for each of the specific XML elements appearing in the XML source data 142 in which the user is interested. The parser functions may be written in any programming language, and embody the logic necessary to apply custom parsing to the content of the XML element in question. In a preferred embodiment, the parser functions are implemented as class members of a C++ class, referred to as a template class, which inherits characteristics from a pre-defined node or element parser class written especially for whichever event-based XML reader that the user will use to access the XML source data 142.

Continuing with preparatory process 304, the user then creates a parsing map 112 for the XML elements in which the user is interested. The parsing map 112 describes the XML elements of interest and maps each of those elements to the particular parsing function that will implement the custom parsing of the content of that element. In a preferred embodiment, the parsing map 112 describes the XML elements by XML element name, and maps those element names to the names 116 of class members that embody the parser functions 122 that implement custom parsing of the content of the XML element.

Continuing with preparatory process 306, the user then creates a pre-parser to pre-parse the XML source data 142 on his or her behalf. In a preferred embodiment, the pre-parser is written as a member of a C++ class, referred to as an implementation class, which inherits characteristics from a pre-defined node or element parser base class written especially for whichever event-based XML reader that the user will use to access the XML source data 142. In operation, processing continues at process block 308, where the pre-parser obtains the user's parsing map 112 via the communication channel 132. In a preferred embodiment, the communication channel 132 is implemented as an interface to the pre-parser, that allows the pre-parser to interpret various parsing maps 112 from one or more users in a uniform manner.

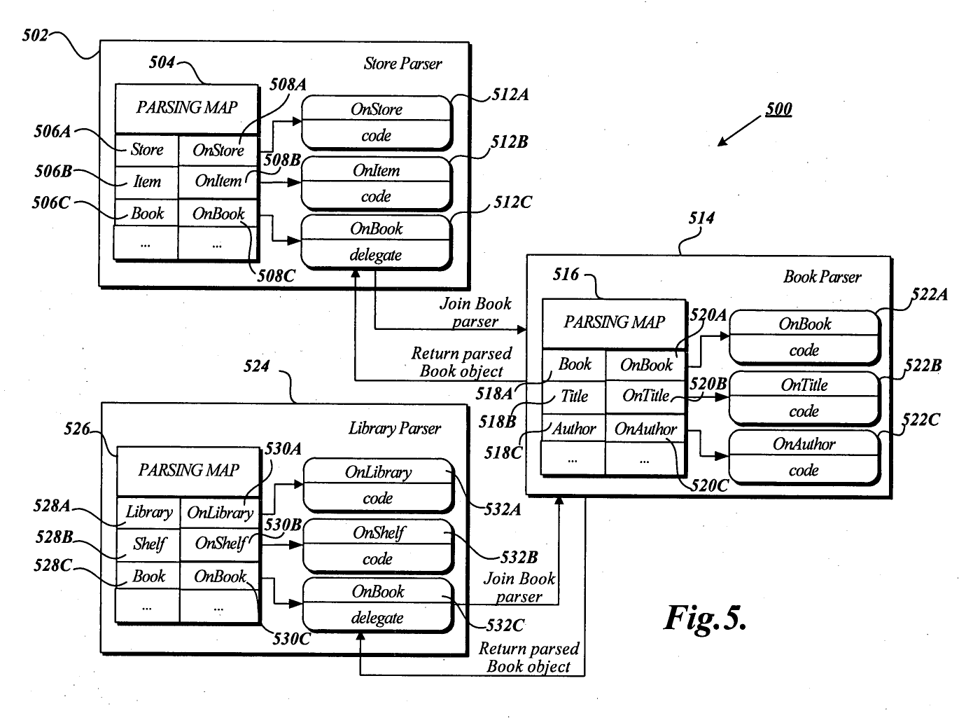

At decision block 310, the user determines whether there are any other previously created parser functions 122 that may be joined to complete the parsing functionality described in parsing map 112. For example, in some cases, the user may map an XML element that has already been described in another map. Rather than create a new parser function for the element, the user may instead join the previously created parser function 122 that was described in the other map. If there are other parser functions that need to be joined, processing continues at processing block 312, to join the additional parser functions as needed via the communication channel 132. The process of joined parsing will be described in further detail in FIG. 5 below.

Processing continues at processing block 314, where the pre-parser generates a parsing agent 134 based on the obtained parsing map(s) 112. The parsing agent 134 will include an internally generated state machine 136 that will pre-parse content from the XML source data 142 in accordance with the information contained in the map(s) 112. In a preferred embodiment, the pre-parser generates the parsing agent 134 and internal state machine 136 when the pre-parser registers itself as a parsing agent of the XML Reader that is responsible for generating events related to the XML source data 142 to which the parsing will be applied. Once registered, the agent 134 is prepared to operate the state machine 136 to consume events generated by the XML Reader on the user's behalf in accordance with the information contained in the map(s) 112. Other means to generate the parsing agent 134 and state machine 136 may be employed without departing from the scope of the claims that follow, as long as the agent 134 and state machine 136 are generated in accordance with the information contained in the obtained parsing map(s) 112.

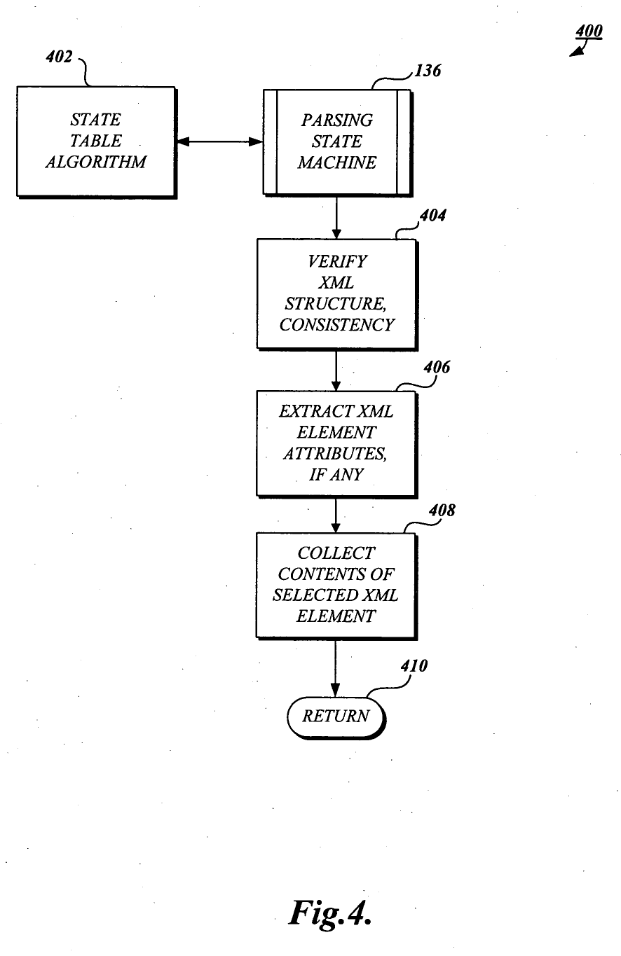

Continuing with reference to FIG. 3B, in operation, at processing block 316, the system 100 commences operation of the event-based API, i.e. the XML Reader, 140 to the XML source data 142. At decision block 318, the agent 134 determines whether the XML Reader has generated an event for an XML element that the user defined in the relevant parsing map 112. If so, then processing continues at processing block 320, where the agent 134 pre-parses the content of the element from the XML source data 142 using the previously generated internal state machine 136. The pre-parsing process is described in further detail in FIG. 4 below. At processing block 322, the system 100 concludes processing after the agent 134 causes the collected content of the XML element of interest to be delivered to the corresponding user-defined parsing function 122 via the communication channel 132, whereupon the parser function 122 applies custom parsing to the content according the logic embodied in the function 122.

FIG. 4 is a flow diagram illustrating the logic 400 performed by a method to facilitate parsing content from an XML document in conjunction with the system 100 illustrated in FIGS. 1 and 2, and in accordance with an embodiment of the present invention. In particular, FIG. 4 illustrates the logic 400 performed by a method to pre-parse the contents of the XML elements. As shown, the parsing state machine 136, as generated by the agent 134 in accordance with the parsing map 112, employs a state table algorithm 402 to accomplish a number of tasks. At processing block 404, the state machine verifies the structure and consistency of the XML elements specified in the parsing map 112. At processing block 406, the state machine further operates to extract the XML elements' attributes, if any. At processing block 408, the state machine further operates to collect the content of the XML elements for return to the appropriate parser function 122 via the communications channel 132. Finally, at termination oval 410, control of the parsing is returned to the agent 134 that generated and initiated the operation of the state machine 134.

FIG. 5 is a block diagram of certain aspects of a set of exemplary parsers used to parse content from an XML document in accordance with an embodiment of the present invention. For the sake of illustration, assume the user wishes to parse content from two XML documents, one describing a store, and one describing a library, as follows:

<store>

. . .
<item>

<price>15.50</price>
<book>

<title>BookTitle</title>
<author>Author</author>
. . .

</book>

</item>
. . .

</store>
<library>

. . .
<shelf>

. . .
<book>

<title>BookTitle</title>
<author>Author</author>
. . .

</book>
. . .

</shelf>
. . .

</library>

Since the book element appears in both the library and store XML documents, it would be advantageous to be able to reuse parser code that the user writes for the book element when parsing the library and store XML documents. In the illustrated example, the user has defined three parsers, a Store Parser 502, a Book Parser 514, and a Library Parser 524. The Store parsing map 504 includes, among others, references to three XML elements of interest, the Store element 506A, the Item element 506B, and the Book element 506C, each of which are mapped respectively to the OnStore parsing function 508A, 512A, the OnItem parsing function 508B, 512B, and the OnBook parsing function 508C, 512C. Likewise, the Book parsing map 516 includes, among others, references to three XML elements of interest, the Book element 520A, the Title element 520B, and the Author element 520C, each of which are mapped respectively to the OnBook parsing function 520A, 522A, the OnTitle parsing function 520B, 522B, and the OnAuthor parsing function 520C, 522C. The Library parsing map 526 also includes, among others, references to three XML elements of interest, the Library element 528A, the Shelf element 528B, and, again the Book element 528C, each of which are mapped respectively to the OnLibrary parsing function 530A, 532A, the OnShelf parsing function 530B, 532B, and the OnBook parsing function 530C, 532C.

In the illustrated embodiment in FIG. 5, the user has delegated the book parsing functions 512C, 532C in the Store parser 502 and Library parser 524 to the existing Book parser 514, which already includes parsing functions created for the book, title, and author elements appearing in the store and library XML documents. In operation, the Book parser 514 may be used to create an in-memory object describing the XML book node of the XML source data that can be reused in both the Store and Library parsers. In one implementation, the Book parser 514 in-memory object may be invoked from the appropriate place in the Store or Library book parsing functions 512C and 532C by calling a joining method of the Book parser 514. For example, using the above-described XML documents and parsing maps, the user may code the following parsing functions 512A, 512B, and 512C for the Store parser 502:

OnStore

. . .

OnItem

item = new Item
item.price = $15.50

OnBook

book = BookParser.JoinParsing()
item.name = book.author + book.title

The above code enables the content of the book, author, and title XML elements to be parsed from the Store XML document by reusing the parsing map 516 and parsing functions 520, 522 already set up for the Book parser 514. After the book node custom parsing functions are complete, parsing control returns to Store parser. The same process may be used in the Library parser 524 by calling the same joining method of the Book parser 514 from the book parsing function 532C of the Library parser 524. It is understood that the particular joining method described above is for the sake of illustration only, and that other programming processes or techniques to create reusable parsing functions that can be joined to the functionality described in parsing maps 112 may be employed without departing from the scope of the claims that follow.

FIG. 6 is a block diagram of an exemplary parser and agent used to implement parsing content from an XML document using a SAX Library Reader in accordance with an embodiment of the present invention. For the sake of illustration, assume the user wishes to parse content from an XML document 630 in a SAX Library 624 of XML source data having a Title, Author, Text, and other elements, as follows:

<Document>

<Title/>
<Author/>
<Text>

...

</Text>
<Bibliography/

... .

</Document>

For the user and template components comprising the parser, the user provides a User Class library 602 that includes a parsing map 604 describing the names 606 of the XML elements of interest, here the Document element 606A, the Author element 606B, and the Text element 606C, among others. The map 604 further identifies the corresponding User Class member names 608 of the custom parsing functions 612 that the user has provided for each of the elements, specifically the OnDocument member/function 608A, 612A, the OnAuthor member/function 608B, 612B, and the OnText member/function 608C, 612C.

For the implementation component, comprising the agent, communication channel, and state machine, the user activates a CSAXNodeParse class 614 specifying the user's User Class library 602. The CSAXNodeParse class 614 in turn activates a CSAXNodeParseBase class 616 to register as a parsing agent 134 of the SAX Library Reader 624, and to further generate a parsing state machine 618 based on the parsing map 604 exposed 610 in the user's User Class library 602.

In operation, the SAX Library Reader 624 passes events generated for elements of the XML source data 630 to the generated parsing state machine 618. For example, when the SAX Library Reader 624 encounters the Text element in the XML source data 630, a <Text> event 628 is sent to the state machine 618 indicating that an occurrence of the Text element is available to be pre-parsed. The parsing state machine 618 collects the contents of the Text element, and refers to the map 604 to lookup 616 the appropriate parsing function 608 to which the contents of the Text element should be passed. The contents of the Text element 622 are then passed 630 via the communication channel 132 formed by the operation of the CSAXNode Parse class/agent 614, 134 to the appropriate parsing function 612 in the User Class library 602, in this case the OnText parsing function 612C. In turn, the OnText parsing function 612C applies the user-written custom parsing to the contents of the Text element, resulting in the parsed contents of the Text element 632.

While the presently preferred embodiments of the invention have been illustrated and described, it will be appreciated that various changes may be made therein without departing from the spirit and scope of the invention. For example, in one embodiment of the present invention, the various components of the system 100 to facilitate parsing of an XML document 100 and, in particular, the functionality of the various system components 110, 120, 130, and 140, as described with reference to the parsing map 112, parsing functions 122, communication channel 132, agent 134, and parsing state machine 136, may be implemented in different combinations of processes, programs, or interfaces, and may be distributed across one or more computing devices.

1. A method for facilitating parsing XML data, the method comprising:
creating a parsing function;
mapping an XML element to the parsing function;
exposing the mapping to an agent via a communication channel;
receiving an event for the element from an event-based reader of XML data containing the element;
pre-parsing the content of the element using a state machine automatically generated by the agent in accordance with the exposed mapping; and
sending the pre-parsed content of the element via the communication channel to the parsing function.

2. The method of claim 1, wherein the parsing function is a member of a user class library, and mapping the XML element to the parsing function includes creating a parsing map describing the XML element and identifying the class member associated with the XML element.

3. The method of claim 2, wherein sending the pre-parsed content of the mapped XML element via the communication channel to the parsing function includes looking up the class member identified as being associated with the XML element, and sending the pre-parsed content of the XML element to the associated class member.

4. The method of claim 2, wherein the parsing function is a reusable object to which the XML element has been previously mapped, and mapping the XML element to the parsing function includes:
creating the parsing map describing the XML element and identifying the reusable object associated with the XML element; and
joining the reusable object to the other parsing functions described in the parsing map.

5. The method of claim 1, wherein the agent is an implementation class member and the communication channel is an interface to the implementation class member that enables the mapping to be exposed to the agent automatically.

6. The method of claim 1, wherein the event-based reader of XML data is a SAX reader, and receiving the event for the mapped XML element includes selecting from a plurality of events that have been pushed by the SAX reader only those events that are associated with the mapped XML element.

7. The method of claim 1, wherein pre-parsing the content of the XML element includes at least one of verifying a structure of the XML element relative to other XML elements occurring in the XML data, verifying a consistency of the XML element, extracting an attribute of the XML element, and collecting a content of the XML element.

8. The method of claim 1, further comprising:
mapping an XML element that was previously mapped to an existing parsing function;
joining the existing parsing function to the created parsing function;
sending the pre-parsed content of the mapped XML element via the communication channel to the joined parsing functions.

9. A system for parsing XML data, the system comprising:
a library of custom parsing functions to parse content of XML elements;
a parser having a map that associates custom parsing functions with XML elements;
a communication channel;
an agent that obtains the content of an XML element on behalf of the parser in accordance with the map, wherein the map is accessed via the communication channel, and further where the agent passes the content to the associated custom parsing function via the communication channel.

10. The system of claim 9, wherein the library of custom parsing functions is a class library of members that receive content from the agent via the communication channel.

11. The system of claim 10, wherein the map associates custom parsing functions with XML elements by associating a member name to an XML element name.

12. The system of claim 9, wherein at least one of the parsing functions is a reusable object to which an XML element has been previously associated, and the parser joins the reusable object to the other parsing functions in the map.

13. The system of claim 9, wherein the agent is an implementation class member and the communication channel is an interface to the implementation class member that enables the agent to access the map automatically.

14. The system of claim 9, further comprising an event-based reader, wherein the agent obtains the content of the XML element on behalf of the parser, including handling events generated for the XML element by the event-based reader.

15. The system of claim 14, wherein the event-based reader of XML data is a SAX reader, and handling events generated for the XML element includes at least one of verifying a structure of the XML element relative to other XML elements occurring in the XML data, verifying a consistency of the XML element, extracting an attribute of the XML element, and collecting the content of the XML element.

16. The system of claim 9, wherein the agent obtains the content of the XML element on behalf of the parser using a state machine generated in accordance with the map.

17. A computer-accessible medium having components for parsing XML data, the medium comprising instructions to:
associate an XML element with a parsing function;
expose the association to an agent via a communication channel;
activate the agent to process events for the XML element using the exposed association, the events being generated by an event-based interface to an XML data source containing the XML element;
send a content of the XML element to the associated parsing function via the communication channel; and
apply the parsing function to the content.

18. The computer-accessible medium of claim 17, wherein the parsing function is a member of a user class library, and the instruction to associate an XML element with the parsing function includes an instruction to create a map that defines the XML element by element name, and describes the parsing function by the function's user class library member name.

19. The computer-accessible medium of claim 17, wherein the instruction to activate the agent includes an instruction to register the agent with the event-based interface to the XML data source that contains the XML element in the exposed association.

20. The computer-accessible medium of claim 17, wherein the instruction to activate the agent to process events for the XML element using the exposed association includes an instruction to generate a state table algorithm corresponding to the exposed association, where the agent processes the events using the state table algorithm.

21. The computer-accessible medium of claim 17, wherein the instruction to activate the agent to process events for the XML element using the exposed association includes an instruction to perform at least one of verifying a structure of the XML element relative to other XML elements occurring in the XML data source, verifying a consistency of the XML element, extracting an attribute of the XML element, and collecting a content of the XML element.

22. The computer-accessible medium of claim 17, wherein the instruction to send a content of the XML element to the associated parsing function via the communication channel includes an instruction to invoke the parsing function with the content of the XML element using a callback method.

23. The computer-accessible medium of claim 17, wherein the parsing function includes a reusable object with which the XML element has been previously associated, and the instructions further comprise an instruction to join the reusable object to the parsing function.

24. The computer-accessible medium of claim 17, wherein the agent is a member of an implementation class library and the communication channel is an interface to the implementation class member that exposes the association between the XML element and the parsing function to the agent automatically.

25. The computer-accessible medium of claim 17, wherein the event-based reader of XML source data is a SAX reader, and the instruction to process the event for the associated XML element includes an instruction to select from a plurality of events generated by the SAX reader only those events related to the associated XML element.

26. A method for parsing XML elements contained in an XML data source, the method comprising:
creating a map that associates custom parsing functions with XML elements;
registering an agent with a SAXReader to process events generated by the SAXReader for the mapped XML elements;
commencing the SAXReader to read XML elements contained in an XML data source;
pre-parsing the content of at least one of the mapped XML elements using a state machine automatically generated by the agent in accordance with the map;
sending the pre-parsed content of the XML element to the associated parsing function specified in the map; and
applying the parsing function to the content of the XML element.

27. The method of claim 26, wherein the parsing function is a member of a user class library, and the map associates the function with the XML element by the class member's name.

28. The method of claim 27, wherein sending the pre-parsed content of the XML element to the associated parsing function includes looking up the class member name, and invoking the class member with the pre-parsed content.

29. The method of claim 26, wherein the custom parsing function is a reusable object with which the XML element has been previously associated, and creating the map includes joining the reusable object to the other parsing functions described in the map.

30. The method of claim 26, wherein registering the agent includes establishing a communication channel through which the agent access the map, and further through which the agent sends the pre-parsed content of the XML element to the associated parsing function specified in the map.
